(19) United States
(12) Patent Application Publication
(10) Pub. No.: US 2026/0071154 A1
(43) Pub. Date: Mar. 12, 2026

(54) A DETERGENT SHEET

(71) Applicant: CONOPCO, INC., D/B/A UNILEVER, Englewood Cliffs, NJ (US)

(72) Inventors: Girish MURALIDHARAN, Banashankari (IN); Vishal Mohan UDMALE, Virar (IN)

(21) Appl. No.: 19/105,925

(22) PCT Filed: Aug. 18, 2023
(86) PCT No.: PCT/EP2023/072788

§ 371 Date: Feb. 24, 2025

(30) Foreign Application Priority Data
Aug. 25, 2022 (EP) 22192160.4

(51) Int. Cl. C11D 17/06; C11D 1/22; C11D 3/22; C11D 3/36; C11D 11/00

(52) U.S. Cl. CPC C11D 17/06; C11D 1/22; C11D 3/225; C11D 3/361; C11D 11/00

(57) ABSTRACT

The present invention is in the field of cleaning compositions. More particularly, the present invention relates to a detergent sheet for providing a cleaning composition on dissolution. There is a need to provide an improved ‘eco-friendly’ detergent sheet having detergent adjuncts for delivering a cleaning efficacy at par with conventional products. It is found that a water-soluble polymer comprising a cellulose ether derivative and a swellable disintegrant having high water absorption ratio provides a stable ‘eco-friendly’ detergent sheet containing a sequestrant and surfactant. The sheet dissolves quickly in water and provides enhanced cleaning efficacy. Further it does not stick to each other on storage, thus easy to use. The present invention further describes a process of making the detergent sheet and a process of providing a cleaning composition from the detergent sheet.

### FIELD OF THE INVENTION

The present invention is in the field of cleaning compositions. More particularly, the present invention relates to a detergent sheet providing a cleaning composition on dissolution in water.

### BACKGROUND OF THE INVENTION

Consumers prefer to use various cleaning products for their house-hold chores. Laundry detergent, dishwashing detergent, hard surface cleaners are few examples of such cleaning products. Often these products are available in various formats, such as, powder, bar, liquid, pods, sheet etc.

Detergent products often contain detersive active for cleaning and certain additional ingredients for enhancing the cleaning efficacy and sensory. Such ingredients include sequestrant, soil release polymer, anti-redeposition polymer, anti-foaming agent, and perfume. Conventional detergent products further contain substantial amount of a carrier material, mostly, it is water in liquid format and inert fillers in solid format. This often makes the product bulky, thereby the product consumes significant amount of packaging materials, like, polyethylene, polyethylene terephthalate, polystyrene, which are predominantly sourced from non-renewable sources.

It is observed that consumers are now-a-days concerned about the environment. They prefer ‘eco-friendly’ or ‘environmental-friendly’ products, i.e., the products which contain natural or biodegradable ingredients or ingredients are sourced through renewable routes or have less or no impact on the environment when the product is made or used.

Product in concentrated format is one of the steps in this direction. Consumer procures a concentrated product, doses it in washing vessels providing a washing solution. Alternatively, he/she may make a detergent by diluting/dissolving it in water and use it later. Such products are compact in size, consume lesser packaging substrate, thus reduce the consumption of packaging material. Further, processing and handling of such products, particularly transportation, has lesser impact on environment, since it is possible to carry/handle a large number of such products in single instant compared to conventional products.

In this regards, detergent sheet is one of the emerging product formats. Typically, detergent sheets contain detersive actives in a water-soluble polymer matrix. Consumers are supposed to dissolve the sheet in water to generate a wash liquor or a liquid detergent and use it. It is desired that a product in sheet format should have detersive active and other ingredients in sufficient quantity to provide a cleaning efficacy at par with the conventional detergent products. It is further desired that the sheet dissolves quickly in water and should be easy to use.

In this regard, WO 2022/126232 (Dizolve Group Corp., 2022) discloses a water-soluble sheet for delivering a cationic biocide composition, such as benzalkonium chloride, to a volume of water for use as a hard surface cleaner or disinfectant.

CN 107 201 279 (Kesh Chemical Ind Shenzhen Co. Ltd., 2017) discloses a washing tablet and preparation method thereof. The tablet is prepared from a film forming agent, a non-ionic surfactant, an anionic surfactant, a zwitterionic surfactant, a moisturizer, a chelating agent, a preservative, edible pigment, natural essence and the like, and is prepared by the following steps of weighing, pulping, tabletting and the like.

CN 105 886 145 (Mingyan Biological Tech Co Ltd., 2016) discloses a super-concentrated washing piece and manufacturing methods thereof. The super-concentrated washing piece is prepared from 15 to 60% of anion active agent, 15 to 45% of non-ionic surfactant, 1 to 20% of ampholytic surfactant, 2 to 6% of small molecule peptide compound enzyme, 1 to 3% of thickening agent, 0.1 to 0.5% of antibacterial agent, 0.1 to 0.3% of preservative, 0.1 to 1% of aromatic, 1 to 3% of filler and an appropriate amount of deionized water.

WO 2017/164569 A1 (Yoo Shi Chang, 2017) discloses a paper-type detergent comprising 10 to 20 parts by weight of starch, 25 to 35 parts by weight of a non-ionic surfactant, 8 to 12 parts by weight of an anionic surfactant, 10 to 20 parts by weight of an emulsifier, 6 to 10 parts by weight of a dispersant, 10 to 15 parts by weight of a film forming agent, 2 to 5 parts by weight of a composite enzyme, 2 to 4 parts by weight of a nano-silver antibacterial agent and 3 to 5 parts by weight of deionized water.

EP 1 163 895 A1 (Kao Corp., 2001) discloses detergent compositions comprising components (A) and (B):(A) 3 to 60% by weight of at least one surfactant selected from anionic surfactants, amphoteric surfactants and hydrophilic non-ionic surfactants; and (B) 0.1 to 50% by weight of fibre having an average fibre length of 0.02 to 1 mm.

Further, polyvinyl alcohol (PVA) based detergent sheets are known in the art. However, polyvinyl alcohol is mostly sourced through non-renewable routes. Further, it is observed that polyvinyl alcohol is not compatible with certain ingredients, for example, sequestrants or soil release polymers or anti-redeposition polymers having carboxylic acid as a functional group.

Such ingredients are included in conventional detergent products for improving cleaning performances and efficacy; however, may not be possible to include them in PVA based detergent sheets. Thus, the efficacy of such detergent sheets may be compromised compared to conventional detergent products.

Therefore, there is a need to provide an improved ‘eco-friendly’ detergent sheet having detergent adjuncts for delivering a cleaning efficacy at par with conventional products.

The present inventors surprisingly have found that a water-soluble polymer comprising a cellulose ether derivative and a swellable disintegrant having high water absorption ratio provides a stable ‘eco-friendly’ detergent sheet containing a sequestrant and a surfactant. The sheet dissolves quickly in water and provides enhanced cleaning efficacy. Further it does not stick to each other on storage, thus easy to use.

### SUMMARY OF THE INVENTION

In a first aspect, the present invention provides A detergent sheet for providing a cleaning composition on dissolution in water comprising:
a) 15 to 80% by weight of a surfactant;
b) a water-soluble polymer comprising a cellulose ether derivative; and
c) a swellable disintegrant having water absorption ratio greater than 1; and
d) a sequestrant.

In another aspect, the present invention provides a process for making a detergent sheet comprising steps of:
a) providing a liquid premix comprising
   i. a surfactant;
   ii. a water-soluble polymer comprising a cellulose ether derivative;
   iii. a swellable disintegrant having water absorption ratio greater than 1; and
   iv. water;
b) casting the premix on a surface and allowing the water to evaporate thereby forming the detergent sheet.

In another aspect, the present invention provides a process for providing a cleaning composition comprising steps of:
a) providing a water in a container; and
b) dissolving a detergent sheet according to the first aspect, wherein the ratio of the sheet to water is in the range from 1:5 to 1:6000 by weight.

These and other aspects, features and advantages will become apparent to those of ordinary skill in the art from reading of the following detailed description. For the avoidance of doubt, any feature of one aspect of the present invention may be utilized in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### DETAILED DESCRIPTION OF THE INVENTION

According to the present invention, there is provided a detergent sheet comprising 15 to 80% by weight of a surfactant, a water-soluble polymer comprising a cellulose ether derivative and a swellable disintegrant having water absorption ratio greater than 1 and a sequestrant.

### Surfactant

The detergent sheet comprises 15 to 80% by weight of the surfactant. Preferably the detergent sheer comprises 20 to 75% by weight, more preferably 25 to 70 and most preferably 30 to 65% by weight of the surfactant.

Preferably the surfactant is selected from anionic surfactant, non-ionic surfactant, amphoteric surfactant, and combinations thereof.

Preferably the detergent sheet comprises anionic surfactant. Preferably the anionic surfactant is selected from alkyl sulphate, alkyl ether sulphate, linear alkyl benzene sulphonate and combinations thereof.

Anionic surfactant suitable for the present invention includes salts of organic sulphates and sulphonates having alkyl radicals containing from about 8 to about 22 carbon atoms, the term “alkyl” being used to include the alkyl portion of higher acyl radicals. Examples of such materials include alkyl sulphates, alkyl ether sulphates, alkaryl sulfonates, alpha-olefin sulfonates, and mixtures thereof. The alkyl radicals preferably contain from 10 to 18 carbon atoms and may be unsaturated. The alkyl ether sulphates may contain from one to ten ethylene oxide or propylene oxide units per molecule, and preferably contain one to three ethylene oxide units per molecule.

The suitable anionic surfactant may also include alkylbenzene sulfonates. Preferably in an embodiment suitable for dishwash comprises linear alkylbenzene sulfonates (LAS) with an alkyl chain length of from 10 to 18 carbon atoms. Commercial LAS is a mixture of closely related isomers and homologues alkyl chain homologues, each containing an aromatic ring sulfonated at the “para” position and attached to a linear alkyl chain at any position except the terminal carbons. The linear alkyl chain typically has a chain length of from 11 to 15 carbon atoms, with the predominant materials having a chain length of about C12. Each alkyl chain homologue consists of a mixture of all the possible sulpho-phenyl isomers except for the 1-phenyl isomer. LAS is normally formulated into compositions in acid (i.e., HLAS) form and then at least partially neutralized in-situ. The counterion for anionic surfactants is generally an alkali metal such as sodium or potassium; or an ammoniacal counterion. Mixtures of such counterions may also be employed. Sodium and potassium are preferred.

Preferably the suitable anionic surfactant includes alkyl sulphate surfactant (PAS), such as non-ethoxylated primary and secondary alkyl sulphates with an alkyl chain length of from 10 to 18.

The detergent sheet may contain alkyl ether sulphates having a straight or branched chain alkyl group having 10 to 18, more preferably 12 to 14 carbon atoms and containing an average of 1 to 3 ethylene oxide (EO) units per molecule. A preferred example is sodium lauryl ether sulphate (SLES) in which the predominantly C12 lauryl alkyl group has been ethoxylated with an average of 3EO units per molecule. The alkyl ether sulphates may be used alone or in combination with any other anionic surfactant.

Most preferably the anionic surfactant is selected from primary alkyl sulphate, alkyl benzene sulphonates, alkyl ether sulphates and mixture thereof.

Preferably the amount of the anionic surfactant is in the range up to 100% by weight of the total amount of the surfactant. More preferably, the amount of anionic surfactant is in the range 10 to 100%, even more preferably 20 to 100%, even more preferably 30 to 100% by weight of the total amount of the surfactant. Most preferably the anionic surfactant is in the range of 50 to 100% by weight of the total amount of the surfactant.

Preferably the detergent sheet comprises 8 to 80% by weight, more preferably 15 to 75% by weight, even more preferably 20 to 70% by weight and most preferably 25 to 60% by weight of the anionic surfactant.

The detergent sheet according to the present invention may further comprises a non-ionic and an amphoteric surfactant in addition to the anionic surfactant.

Suitable non-ionic surfactants include water soluble aliphatic ethoxylated non-ionic surfactants including the primary aliphatic alcohol ethoxylates and secondary aliphatic alcohol ethoxylates. This includes the condensation products of a higher alcohol (e.g., an alkanol containing about 8 to 16 carbon atoms in a straight or branched chain configuration) condensed with about 4 to 20 moles of ethylene oxide, for example, lauryl or myristyl alcohol condensed with about 10 moles of ethylene oxide (EO), tridecanol condensed with about 6 to 15 moles of EO, myristyl alcohol condensed with about 10 moles of EO per mole of myristyl alcohol, the condensation product of EO with a cut of coconut fatty alcohol containing a mixture of fatty alcohols with alkyl chains varying from 10 to about 14 carbon atoms in length and wherein the condensate contains either about 6 moles of EO per mole of total alcohol or about 9 moles of EO per mole of alcohol and tallow alcohol ethoxylates containing 6 EO to 11 EO per mole of alcohol.

Examples of the foregoing non-ionic surfactants include, but are not limited to, the Neodol (trade mark, ex Shell), which are higher aliphatic, primary alcohol containing about 9 to 15 carbon atoms, such as C9 to C11 alkanol condensed with 4 to 10 moles of ethylene oxide (Neodol 91-8 or Neodol 91-5), C12 to C13 alkanol condensed with 6.5 moles ethylene oxide (Neodol 23-6.5), C12 to C15 alkanol condensed with 12 moles ethylene oxide (Neodol 25-12), C14 to C15 alkanol condensed with 13 moles ethylene oxide (Neodol 45-13), and the like. Such ethoxamers have an HLB (hydrophobic lipophilic balance) value of about 8 to 15 and give good O/W emulsification, whereas ethoxamers with HLB values below 7 contain less than 4 ethylene oxide groups and tend to be poor emulsifiers and poor detergents.

Another group of suitable non-ionic surfactants are alkylpolyglycoside (APG) which are sugar derivatives of fatty alcohol. Example of such surfactants are decyl glucoside, lauryl glucoside, myristyl glucoside.

Preferably the detergent sheet comprises 0 to 50% by weight, more preferably 5 to 45% by weight, even more preferably 10 to 40% by weight and most preferably 15 to 35% by weight of the non-ionic surfactant.

The detergent sheet may comprise an amphoteric surfactant in addition to anionic and/or non-ionic surfactant. Suitable amphoteric surfactants include derivatives of aliphatic quaternary ammonium, sulphonium and phosphonium compounds having an aliphatic radical of from 8 to 18 carbon atoms and an aliphatic radical substituted by an anionic water-solubilising group, for instance 3-(N-N-dimethyl-N-hexadecylammonium) propane-1-sulphonate betaine, 3-(dodecylmethyl sulphonium) propane-1-sulphonate betaine and 3-(cetylmethylphosphonium) ethane sulphonate betaine.

Examples of amphoteric surfactants suitable for the present invention include cocoamidopropyl betaine (CAPB), cocoamidopropyl amine oxide (CAPAO), cocodiethanol amide (CDEA) and cocomonoethanol amide (CMEA).

Preferably the detergent sheet comprises 0 to 30% by weight, more preferably 1 to 25% by weight, and even more preferably 2 to 20% by weight and most preferably 3 to 15% by weight of the amphoteric surfactant.

Preferably the surfactant comprises a combination of anionic surfactant, non-ionic surfactant, and amphoteric surfactant. It is observed that the combination of surfactants further accelerates dissolution of the detergent sheet. The ratio of the anionic surfactant to non-ionic surfactant to amphoteric surfactant preferably at least 3:1:1 by weight. Preferably the ratio of the anionic to non-ionic to amphoteric surfactant is in the range from 3:1:1 to 10:1:1 by weight.

### Water Soluble Polymer

The detergent sheet comprises a water-soluble polymer. Since the present invention provide a product in sheet format, water-soluble polymer acts as carrier or matrix for the format.

Preferably water-soluble polymer is readily soluble in water at 25° C. The term “readily soluble” herein implies that the polymer dissolves in water thereby providing a visually clear or transparent solution, without leaving any lump in the solution. Visually clear or transparent herein, refers to a solution having a turbidity value less than 50 NTU (Nephelometric turbidity unit)

The water-soluble polymer comprises a cellulose ether derivative. Typically, cellulose ether derivatives are obtained by substituting one or more hydrogen atoms of hydroxyl groups in the anhydro-glucose units of cellulose with alkyl or substituted alkyl groups. Degree of substitution (DS) is one of the factors that define the properties of cellulose ether derivatives, particularly, solubility in water. It is defined as the number of substituted hydroxyl groups for every glucose molecule ranging between zero and three. For example, cellulose ether derivatives with degree of substitution values between 1.2 to 2.4 are soluble in cold water. Examples of cellulose ether derivatives suitable for the present invention includes methyl cellulose, hydroxyethyl cellulose, hydroxypropyl cellulose, hydroxypropyl methyl cellulose, carboxymethyl cellulose and sodium carboxymethyl cellulose.

Preferably the cellulose ether derivative is selected from cellulose alkyl ether derivative or cellulose hydroxyalkyl ether derivative. Non-ionic cellulose ether derivatives, i.e., derivatives containing non-ionic functional group, such as, hydroxy, methoxy, ethoxy, hydroxyethyl, hydroxy propyl, di-hydroxy propyl and dihydroxy butyl, are preferable for the present invention.

Preferably the cellulose ether derivative is selected form hydroxypropyl methyl cellulose, hydroxy ethyl cellulose, hydroxypropyl cellulose, and combinations thereof. Most preferred cellulose ether derivative is hydroxypropyl methyl cellulose.

Typically, pure cellulose is hardly soluble in distilled water, however it forms gel by absorbing water. Hence, it may not be used as carrier or matrix for the sheet format.

Non limiting examples of water-soluble polymers which may also present in the detergent sheet includes, gelatine, and polysaccharide e.g., xanthan gum, guar gum, carrageenan gum in addition to the cellulose containing compound.

Preferably the amount of water-soluble polymer in the detergent sheet is in the range 5 to 50% by weight, more preferably 7 to 45% by weight, even more preferably 9 to 40% by weight and most preferably 10 to 35% by weight of the detergent sheet.

Conventionally, a cleaning product or detergent in sheet format comprises polyvinyl alcohol (PVA). PVA is readily available and water-soluble substrate. However, the present invention may not contain PVA as water-soluble polymer. Preferably the detergent sheet is free of polyvinyl alcohol or its derivative. The term ‘free of’ herein implies that the detergent sheet comprises less than 10% by weight, more preferably 8% by weight, even more preferably 5% by weight yet more preferably 3% by weight and most preferably 1% by weight of polyvinyl alcohol and/or its derivative.

### Swellable Disintegrant

The detergent sheet comprises a swellable disintegrant. Swellable disintegrant herein refers to the components which swell in contact with water and there by accelerates dissolution of the detergent sheet. Particularly, in the present invention swellable disintegrant are referring to one which has a water absorption ratio (WAR) of greater than 1. It is observed that the swellable disintegrant in specific amount accelerates the dissolution of the detergent sheet in water and provides a cleaning composition quickly.

Water Absorption Ratio (WAR) is a measure as to how much water a material absorbs under controlled and defined conditions. The process described in ASTM D570 is used in this application.

The swellable disintegrant is preferably selected from microcrystalline cellulose, sodium starch glycolate and mixtures thereof. Most preferred swellable disintegrant is microcrystalline cellulose. Microcrystalline cellulose absorbs water and swells and has WAR value more than 5.

The detergent sheet comprises from 3 to 25% by weight swellable disintegrant. More preferably the detergent sheet comprises from 4 to 24% by weight and most preferably from 5 to 23% by weight of the swellable disintegrant.

The detergent sheet may further comprise a non-swellable disintegrant. Non-swellable disintegrant herein refer to those which have water absorption ratio (WAR) less than 1. Examples of non-swellable disintegrate includes polyvinyl pyrrolidone, calcium silicate, starch, magnesium stearate. The non-swellable disintegrant may present from 0 to 10% by weight of the more preferably from 0.5 to 8% by weight and most preferably from 1 to 5% by weight of the detergent sheet.

### Sequestrant

The composition comprises a sequestrant. Preferably the sequestrant is selected from organic detergent builders or sequestrant materials. Examples of such sequestrants include the alkali metal, citrates, succinates, malonates, carboxymethyl succinates, carboxylates, polycarboxylates and polyacetyl carboxylates. Specific examples include sodium, potassium and lithium salts of oxydisuccinic acid, mellitic acid, benzene polycarboxylic acids, and citric acid. Other examples are DEQUEST™, organic phosphonate type sequestering agents sold by Monsanto and alkanehydroxy phosphonates.

Other suitable organic builders/sequestrants include the higher molecular weight polymers and copolymers known to have builder properties. For example, such materials include appropriate polyacrylic acid, polymaleic acid, and polyacrylic/polymaleic acid copolymers and their salts, for example those sold by BASF under the name SOKALAN™. A preferred sequestrant is Dequest® 2066 (Diethylenetriamine penta(methylene phosphonic acid) or Heptasodium DTPMP). Other suitable sequestrant is HEDP (1-Hydroxyethylidene-1,1,-diphosphonic acid), for example sold as Dequest 2010.

Preferably the sequestrant is selected from amino-phosphonic acid, phosphonic acid, amino carboxylic acid, and salts thereof. Preferably the sequestrant is selected from Diethylenetriamine penta (methylene phosphonic acid-heptasodium salt (DTPMPA), 1-Hydroxyethylidene 1,1-diphosphonic acid (HEDP), Trisodium salt of Methylglycinediacetic acid (MGDA), N, N-Dicarboxymethyl glutamic acid tetrasodium salt (GLDA) and combinations thereof. Most preferred sequestrant is diethylenetriamine penta (methylene phosphonic acid-heptasodium salt (DTPMPA) and/or 1-hydroxyethylidene 1,1-diphosphonic acid (HEDP).

The composition preferably comprises 0.1 to 10% by weight, more preferably 0.2 to 9% by weight, even more preferably 0.3 to 8% by weight and most preferably 0.4 to 7% by weight of the sequestrant.

### Graphene or its Derivative

The detergent sheet may comprise 0.01 to 1.0% by weight graphene or its derivative. Most common graphene derivatives are graphene oxide (GO) and reduced graphene oxide (rGO).

Graphene is an allotrope, formed by a single layer carbon atoms arranged in hexagonal lattice structure. It is reported that graphene or its derivative has good thermal and electrical conductivity, commonly used in various sector of electrical and electronics, e.g., semiconductor, communication, sensors, etc.

Graphene is hydrophobic and can be obtained in two manners. The first is by peeling layers from graphite until you achieve a graphene monolayer. The second is known as Chemical Vapor Deposition (CVD) and where large-scale uniformity can be obtained and controlled.

Preferably the graphene derivative suitable for the invention is graphene oxide. Graphene oxide (GO) is hydrophilic and can be manufactured through Hummer's method. One of the ways to prepare reduced graphene oxide (rGO) is by thermal and/or chemical reduction of graphene oxide. More details on graphene and derivative thereof may be found in literatures, e.g., “Review on graphene and its derivatives: Synthesis methods and potential industrial implementation” Lee et. al., Journal of the Taiwan Institute of Chemical Engineers, Volume 98, May 2019, Pages 163-180, Elsevier. Graphene oxide (GO) is also commercially available and may be procured from suppliers such as Platonic Nanotech.

Preferably the detergent sheet comprises 0.01 to 0.8% by weight, more preferably 0.02 to 0.8% by weight, furthermore preferably 0.05 to 0.7% by weight, yet more preferably 0.08 to 0.6% by weight and most preferably 0.09 to 0.5% by weight of the graphene or its derivative.

### Slip Additive

The detergent sheet may further comprise 1.0 to 10% by weight of a slip additive. Without bound by the theory, it is believed that slip additive reduces the coefficient of friction on the surfaces of the sheets, thus helps providing non-sticky films.

Preferably the detergent sheet comprises 1.0 to 8% by weight, more preferably 1.0 to 7% by weight, even more preferably 1.0 to 6% by weight, furthermore preferably 1.0 to 5% by weight, yet more preferably 1.0 to 4% by weight and most preferably 1.0 to 3% by weight of the slip additive.

Preferably, the slip additive comprises a fatty acid amide. Preferably the slip additive comprises fatty acid amide with 10 to 30 carbon atoms, more preferably 11 to 28 carbon atoms, even more preferably 12 to 26 and yet more preferably 12 to 24 and most preferably 12 to 22 carbon atoms. Preferably, the fatty acid amide is saturated or unsaturated. Where it is unsaturated it is preferred that it is mono- or di-, more preferably mono-unsaturated.

Most preferred slip additives include stearamide, erucamide and oleamide and mixture thereof.

Most preferred slip additives are C18 to C22 mono-unsaturated fatty acid amides and which includes erucamide and oleamide.

### Water

The detergent sheet according to the present invention is in sheet format or dry format. It may not contain significant amount of water, particularly free water. ‘Free water’ herein refers to water added or visually perceivable on the product. However, the process of making the detergent sheet comprises a step of preparing a solution of ingredients in a water and casting on a surface. Thus, it may contain water residue in it. Preferably the detergent sheet comprises less than 25% by weight, more preferably less than 20% by weight and most preferably less than 15% by weight water. Preferably the detergent sheet comprises 5 to 25% by weight, more preferably 5 to 20% by weight, even more preferably 8 to 15% by weight, most preferably 10 to 15% by weight of water and the water is bound to the detergent sheet. Water content may be measured in thermogravimetrically, such as moisture balance or thermogravimetric analyser.

### Further Optional Ingredients

The detergent sheet may further contain optional ingredients to enhance performance and/or consumer acceptability. Examples of such ingredients include foam control or anti foam agent, preservatives (e.g., bactericides), fluorescers, soil release polymer, anti-redeposition polymer, optical brighter, degreaser, dyes, perfume etc. Each of these ingredients will be present in an amount effective to accomplish its purpose. Generally, these optional ingredients are included individually at an amount of up to 10% by weight of the detergent sheet. Examples of soil release polymer suitable for the present invention include co-polyester of dicarboxylic acid, diols, cellulose derivative, and polyester polyamide polymers. Suitable antifoaming agents include silicones and fatty acids.

The detergent sheet may comprises an effective amount of one or more enzyme preferably selected from the group comprising, hemicellulases, peroxidases, proteases, cellulases, hemicellulases, xylanases, xantanase, lipases, phospholipases, esterases, cutinases, pectinases, carrageenases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, tannases, amylases, nucleases (such as deoxyribonuclease and/or ribonuclease), phosphodiesterases, or mixtures thereof. Particularly preferred are mixtures of protease, amylase, lipase, cellulase, phosphodiesterase, and/or pectate lyase.

Since the present invention provides a product in sheet format, it may optionally contain conventional additives used in packaging or film substrates. Examples of such ingredients include, but are not limited to, an antioxidant, a foaming agent, a dye, fillers, colourants, a cross-linking agent, an inhibitor, pigment, stabiliser, biocidal.

### Process of Making the Detergent Sheet

There is provided a process for making the detergent sheet. The process comprises steps of preparing a liquid premix in water. The premix comprises a surfactant, a water-soluble polymer comprising a cellulose ether derivative, a swellable disintegrant having water absorption ratio greater than 1, a sequestrant and water. Examples, class and types of the surfactants, water-soluble polymer swellable disintegrants and sequestrants described hereinabove are suitable for incorporation in the process. Ingredients may be available in powder or dry solid format, which may also be useful for the present invention.

The premix is prepared by providing water in a container, adding the water-soluble polymer to the water and mixing it. The homogenisation process may include heating the water to enhance solubility of the polymer. Subsequently, the surfactant, the swellable and the sequestrant are added to the premix. Thereon the premix is casted on a surface as a sheet or film with certain thickness. Preferably the thickness is controlled using an applicator. Casting process includes removing the water by evaporation, thereby provides the detergent sheet. The casting may take place in room temperature or at an elevated temperature, preferably at less than 100° C., and more preferably less than 95° C. Most preferably the casting process takes place at 70 to 90° C. Process of making the detergent sheet may also include any other conventional method of forming film or sheets.

Preferably casting removes at least 60% by weight, more preferably at least 70% by weight, even more preferably 80% by weight and most preferably 90% by weight of water. The sheets obtained by the process comprises 5 to 25% by weight of water. Preferably the sheet comprises 5 to 20% by weight, more preferably 8 to 15% by weight and most preferably 10 to 15% by weight of water. In most preferred embodiment, the sheet obtained by the process comprises about 10% by weight of water.

The premix may comprise 3 to 30% by weight of the surfactant. More preferably the premix comprises 4 to 25% by weight and most preferably 5 to 20% by weight of the surfactant.

The premix may comprise 1 to 20% by weight of the water-soluble polymer, more preferably 2 to 15% by weight and most preferably 3 to 12% by weight of the water-soluble polymer.

The premix may comprise 2 to 9% by weight of the swellable disintegrant. Preferably the premix comprises 2.5 to 9% by weight and most preferably 3 to 8% by weight of the swellable disintegrant.

The premix may comprise 0.05 to 5% by weight of the sequestrant. Preferably the premix comprises 0.1 to 4% by weight and most preferably 0.2 to 3% by weight of the sequestrant.

The premix is made by adding water as balance. Preferably the premix comprises 40 to 90% by weight, more preferably 45 to 80% and more preferably 50 to 75% by weight of water.

In said process, each ingredient is taken in an amount with respect to the premix, however, the premix provides the detergent sheet by removing water or concentrating it. Thus, the amount of each ingredient is proportionately increased during the curing process resulting in the detergent sheet according to the first aspect. That is, the detergent sheet obtained by the process preferably contains 15 to 80% by weight of the surfactant, 5 to 50% by weight of the water-soluble polymer and 3 to 25% by weight of the swellable disintegrant and 0.1 to 10% by weight of the sequestrant described hereinabove. Such proportions or ratios are part of any sheet or film making process and it is well-known in the art.

The premix is in liquid form, it has a viscosity such that is suitable to cast on a surface to form a thin layer. The liquid premix may have a viscosity in the range 10 to 2000 mPa·S, more preferably 15 to 1500 mPa·S, even more preferably 20 to 1000 mPa·S and most preferably 25 to 500 mPa·S at 20 S⁻¹ shear rate and 25° C.

### Application

The detergent sheet may be provided in unit does format. The term ‘unit does’ herein refers to a dose of a product suitable for single time use. The detergent sheet may contain plurality of unit dose in a sheet, wherein it is provided with perforation marking indicating a unit dose. In practice, consumers tear a unit dose by the marking and use it.

Preferably the detergent sheet in unit dose format is provided as booklet of sheets, whereas each sheet is suitable for single wash. It is preferable, sheets have low coefficient of friction or may contain slip additives, such that they do not stick together.

The detergent sheet according to the present invention may be formulated for laundering or dishwashing. The term ‘laundering’ herein refers to treating or washing fabrics. The laundering may include hand wash and machine wash. In hand wash, a consumer dissolves a unit dose of the detergent sheet in a bucket of water forming a wash liquor and soak their laundry load in the wash liquor and subsequently wash it. The detergent sheet may be used in machine wash also, wherein consumer dose a unit dose the detergent sheet in a washing machine directly and wash their load. ‘Dishwashing’ herein refers to washing dishes, kitchen utensils crockery and any other hard surface related to cooking or serving foods. In a dishwashing process, consumers preferably dissolve a unit dose of the detergent sheet in an aliquot of water thereby providing a cleaning composition, which thereon be used for dishwashing.

In another scenario, it is possible to formulate the detergent sheet for providing a liquid detergent. The consumer may prepare a liquid detergent by dissolving the detergent sheet in a secondary container and store it for multiple use. The liquid detergent differs from the wash liquor in terms of detersive content and certain product attributes, such as viscosity, sensory.

The detergent sheet according to the present invention may be formulated for hard surface cleaning. Hard surface cleaning compositions are generally used for cleaning surfaces such as, floor, ceramic tiles, kitchen platform, tabletop etc.

There is provided a method for providing a liquid cleaning composition comprising the steps of providing water in a container, adding a detergent sheet according to the present invention, wherein the ratio of the detergent sheet to water is in the range of 1:5 to 1:6000 by weight.

The cleaning composition may be provided in the form of a wash liquor for immediate use. Consumers may dose the detergent sheet into a bucket or washing vessel. In such cases, the ratio of the detergent sheet to water, particularly in case of machine wash, is in the range of 1:500 to 1:6000 by weight, more preferably 1:1000 to 1:5000 by weight, even more preferably 1:1500 to 1:4000 and most preferably 1:2000 to 1:3500 by weight. For an example, a detergent sheet weighing 10 to 20 gm may be dosed in 20 to 40 litre of water containing in a washing machine. Whereas, in case of hand wash, the ratio of the detergent sheet to water may be in the range of 1:50 to 1:2000 by weight, more preferably 1:100 to 1:1000 by weight and most preferably 1:200 to 1:500 by weight. For an example, a detergent sheet weighing 10 to 20 gm may be dosed in 5 to 15 litre of water containing in a bucket or washing vessel.

The cleaning composition may be provided in the form of a liquid detergent. The liquid detergent can be stored in a secondary container and used at a later stage by diluting further in water. In such scenario, the ratio of the detergent sheet to water is in the range from 1:5 to 1:100 by weight, more preferably 1:7 to 1:80 by weight, event more preferably 1:10 to 1:60 by wight and most preferably 1:15 to 1:40 by weight.

### Example

Materials used in the examples are listed below in table 1.

TABLE 1

| Material (% w/w) | Full form | Supplier |
|---|---|---|
| Na-LAS | Sodium linear alkyl benzene | Unger Surfactants, |
| | sulphonate | Norway |
| HPMC | Hydroxypropyl methylcellulose | Shinetsu, Dow, |
| | | Ashland |
| Glycerol | Glycerol | Sigma-Aldrich |
| Tinopal CBC | Di-styryl biphenyl derivative | BASF SE |
| Acusol | Carboxylic copolymer | Dow Chemical |
| | | International Pvt. |
| | | Ltd. |
| Dequest2010 | 1 Hydroxyethylidene 1,1- | Italmatch UK Ltd. |
| | diphosphonic acid | |
| EPEI | Ethoxylated Polyethyleneimine | BASF SE |
| TexCare ® | polyester based copolymers | Clariant Ltd. |
| MCC | Micro-crystalline cellulose | Keval Export |
| Starch | Tapioca starch-grade A | SPAC Starch |
| | | Products Pvt. Ltd. |
| Polyvinyl | Polyvinyl alcohol (Molecular | Kuraray Co. Ltd. |
| alcohol | weight 30000 to 50000 gm/mol) | |

Ex 1 and Ex-A to B were prepared according to the recipe provided in table 2. Amount of each ingredient mentioned in the table are in consideration with the premix solution used to cast it in sheet format. Ex-1 is within the scope of the invention, Ex-A and B are comparatives having polyvinyl alcohol and starch as water-soluble polymer respectively.

Hydroxypropyl methyl cellulose (HPMC) was weighed and dissolved in hot water (80° C.) to provide a homogenised premix. Subsequently, rest of the ingredients were weighed, added to the premix, and mixed thoroughly. The premix was casted on a surface using TQC Compact film applicator (TQC Sheen) with a draw-dawn applicator to form a wet film. The film was allowed to dry at 70 to 90° C. for 2 hours forming a detergent sheet.

For evaluating the dissolution of the detergent sheet, each example was added in 250 ml water and allowed to dissolve. The time of dissolution was noted using a stopwatch. Coefficient of Friction Tester: M10D (Packtest Machines Inc.) following ASTM D-1814 method.

TABLE 2

| Material (% w/w) | Ex-3 | Ex-A | Ex-B |
|---|---|---|---|
| Na-LAS | 12.2 | 12.2 | 12.2 |
| HPMC | 4.4 | 0.0 | 0.2 |
| Polyvinyl alcohol | 0.0 | 4.4 | 0.0 |
| Starch | 0.0 | 0.0 | 4.4 |
| Glycerol | 1.4 | 1.4 | 1.4 |
| Tinopal CBC | 0.5 | 0.5 | 0.5 |
| Acusol | 3.0 | 3.0 | 3.0 |
| Dequest2010 | 0.5 | 0.5 | 0.5 |
| EPEI | 2.1 | 2.1 | 2.1 |
| Texcare | 1.0 | 1.0 | 1.0 |
| Perfume | 2.2 | 2.2 | 2.2 |
| MCC | 8.0 | 8.0 | 8.0 |
| Water | Up to 100 | Up to 100 | Up to 100 |
| Observation | | Does not | Does not |
| | | form sheet | form sheet |
| Dissolution time | 120 sec | — | — |
| COF | 0.65 | — | — |

Lower the dissolution time is better, as it provides the cleaning composition quickly. Lower coefficient of friction (COF) implies lesser sticky sheets and easy to use. It is evident from table 2, Ex-1 dissolves quickly, yet has ow coefficient of friction. Comparative examples Ex-A and B formed layers on casting, however, were not peelable, thus failed to provide detergent sheets.

The detergent sheets were formed by casting the premixes and evaporating the water from the premix. The water content of the detergent sheets was to 10 to 15% by weight. This resulted in scaling-up the amount of each ingredient proportionately.

Accordingly, the amount of each ingredient for Ex-1 and Ex-A, B are estimated considering 10% water content and summarised below in table 2A.

TABLE 2A

| Material (% w/w) | Ex-1* | Ex-A* | Ex-B* |
|---|---|---|---|
| Na-LAS | 31.1 | 31.1 | 31.1 |
| HPMC | 11.2 | 0.0 | 0.0 |
| Polyvinyl alcohol | 0.0 | 11.2 | 0.0 |
| Starch | 0.0 | 0.0 | 11.2 |
| Glycerol | 3.6 | 3.6 | 3.6 |
| Tinopal CBC | 1.3 | 1.3 | 1.3 |
| Acusol | 7.6 | 7.6 | 7.6 |
| Dequest2010 | 1.3 | 1.3 | 1.3 |
| EPEI | 5.4 | 5.4 | 5.4 |
| Texcare | 2.5 | 2.5 | 2.5 |
| Perfume | 5.6 | 5.6 | 5.6 |
| MCC | 20.4 | 20.4 | 20.4 |
| Water | 10.0 | 10.0 | 10.0 |

*detergent sheet format.

1. A detergent sheet for providing a cleaning composition on dissolution in water comprising:
a) 15 to 80% by weight of a surfactant;
b) a water-soluble polymer comprising a cellulose ether derivative; and
c) a swellable disintegrant having water absorption ratio greater than 1 as measured using ASTM D570 method and wherein the swellable disintegrant is selected from the group consisting of microcrystalline cellulose, sodium starch glycolate and mixtures thereof; and,
d) a sequestrant selected from the group consisting of amino-phosphonic acid, phosphonic acid, amino carboxylic acid and salts thereof,
wherein the cellulose ether derivative is obtained by substituting one or more hydrogen atoms of hydroxyl group in the anhydro-glucose units of cellulose with alkyl or substituted alkyl group wherein the detergent sheet is free of polyvinyl alcohol and wherein the amount of the water-soluble polymer is in the range from 5% to 50% by weight of the detergent sheet.

2. A detergent sheet as claimed in claim 1 wherein the surfactant is selected from anionic surfactant, non-ionic surfactant, amphoteric surfactant and combinations thereof.

3. A detergent sheet as claimed in claim 2 wherein the anionic surfactant is in the range 50% to 100% by weight of total amount of the surfactant.

4. A detergent sheet as claimed in claim 1 wherein the cellulose ether derivative is selected from hydroxypropyl methyl cellulose, methyl cellulose, hydroxypropyl cellulose, and combinations thereof.

5. A detergent sheet as claimed in claim 4 wherein the cellulose ether derivative is hydroxypropyl methyl cellulose.

6. A detergent sheet as claimed in claim 1 wherein the amount of the sequestrant is in the range 0.1 to 10% by weight of the detergent sheet.

7. A detergent sheet as claimed in claim 1 wherein the sequestrant is selected from diethylenetriamine penta (methylene phosphonic acid-heptasodium salt (DTPMPA), 1-hydroxyethylidene 1,1-diphosphonic acid (HEDP), trisodium salt of methylglycinediacetic acid (MGDA), N, N-dicarboxymethyl glutamic acid tetrasodium salt (GLDA) and combinations thereof.

8. A detergent sheet as claimed in claim 7 wherein the sequestrant is diethylenetriamine penta (methylene phosphonic acid-heptasodium salt (DTPMPA) and/or 1-hydroxyethylidene 1,1-diphosphonic acid (HEDP).

9. A detergent sheet according to claim 1 wherein the swellable disintegrant is in an amount ranging from 3 wt. % to 25 wt. % by weight of the sheet.

10-12. (canceled)

13. A process for making a detergent sheet comprising steps of:
a) providing a liquid premix comprising:
i. a surfactant;
ii. a water-soluble polymer comprising a cellulose ether derivative;
iii. a swellable disintegrant having water absorption ratio greater than 1 as measured using ASTM D570 method and wherein the swellable disintegrant is selected from the group consisting of microcrystalline cellulose, sodium starch glycolate and mixtures thereof; and
iv. sequestrant selected from the group consisting of amino-phosphonic acid, phosphonic acid, amino carboxylic acid and salts thereof; and,
v. water:
b) casting the premix on a surface and allowing the water to evaporate thereby forming the detergent sheet,
wherein the cellulose ether derivative is obtained by substituting one or more hydrogen atoms of hydroxyl group in the anhydro-glucose units of cellulose with alkyl or substituted alkyl group and wherein the detergent sheet is free of polyvinyl alcohol and wherein the amount of the water-soluble polymer is in the range from 5% to 50% by weight of the detergent sheet.

14. The process as claimed in claim 13 wherein the amount of water in the detergent sheet is in the range 5% to 25% by weight of the detergent sheet.

15. The process for providing a cleaning composition comprising:
a) providing water in a container; and,
b) dissolving a detergent sheet as claimed in claim 1, wherein the ratio of the detergent sheet to water is in the range from 1:5 to 1:6000 by weight.
